(19) United States
(12) Patent Application Publication
(10) Pub. No.: US 2011/0130178 A1
(43) Pub. Date: Jun. 2, 2011

(54) SLIDING-TYPE PORTABLE TERMINAL

(75) Inventors: Hyun-Suk SHIN, Gyeongsangbuk-do (KR); Seok-Gyu LEE, Gyeonggi-do (KR); Jeong-Hun SEO, Gyeonggi-do (KR)

(73) Assignee: SAMSUNG ELECTRONICS CO., LTD., Gyeonggi-Do (KR)

(21) Appl. No.: 12/873,566

(22) Filed: Sep. 1, 2010

(30) Foreign Application Priority Data
Nov. 27, 2009 (KR) 10-2009-0115545

(51) Int. Cl. H04W 88/02

(52) U.S. Cl. 455/575.4

(57) ABSTRACT

A sliding-type portable terminal including a first housing, a second housing assembled with the first housing in such that the second housing is linearly movable relative to the first housing while being in contact with the first housing. The second housing is formed of a front case and a rear case, and sliding rails are assembled with inner surfaces on both sides of the rear case, respectively. A sliding guide is arranged on the first housing, and includes first guide grooves slidably holding both sides of the rear case. Second guide grooves extend with the first guide grooves in parallel and slidably holding the sliding rails, respectively. The portable terminal restricts unnecessary movement of the second housing relative to the first housing, and achieve smooth sliding of the housings.

### CLAIM OF PRIORITY

This application claims priority under 35 U.S.C. §119(a) from a Korean Patent Application entitled “Sliding-Type Portable Terminal” filed in the Korean Intellectual Property Office on Nov. 27, 2009 and assigned Serial No. 10-2009-115545, the contents of which are incorporated herein by reference in its entirety.

### BACKGROUND OF THE INVENTION

1. Field of the Invention

The present invention relates to a sliding-type portable terminal and improvements in housings. More particularly, the present invention relates to a sliding-type portable terminal having a pair of housings coupled together while facing each other in such a manner that one of the housings can linearly slide on the other housing.

2. Description of the Related Art

In general, a portable terminal refers to a communicative device enabling a user to use one or more communication functions and various contents, such as a game, a moving picture, an electronic book, and digital multimedia broadcasting, while carrying it. With the recent advancements in the functionality of the mobile communication service, the portable terminal is widely used.

Portable terminals are classified into a number of categories that include bar-type terminals, flip-type terminals, folder-type terminals, and sliding-type terminals according to their appearance, particularly as to how they open or close. Because of the additional compactness and portability, the folder-type and sliding-type terminals occupy most of the market. Then, with the advancement of the broadcasting and multimedia service capability of portable terminals, the demand for a relatively larger display device with a touch screen is in great demand such that the popularity of the bar-type terminal has gradually increased.

In the meantime, the folder-type or sliding-type terminal has a structure in which a pair of housings are coupled to each other in such a manner that one housing can be used to open/close the other housing. Taking into consideration the reliability and durability of the terminal, and sensibility of the user, a stable opening/closing operation is necessarily required in the folder-type or sliding-type terminal.

However, there is a problem in that if one desires to secure the structural stability of the folder-type or sliding-type terminal, the normally smooth opening/closing operation of the terminal may degrade, and if one desires to secure the smooth opening/closing operation of the terminal, the structural stability of the terminal may decrease. At the present time, the folder-type terminal has an assembling structure between housings only at the hinge assembling part. In contrast, since the sliding-type terminal has a sliding assembling structure arranged along the entire length of the two housings, there are a lot of difficulties in achieving both the structural stability and the smooth opening/closing operation in the sliding-type terminal.

In other words, the sliding-type terminal should secure a section for the opening/closing operation in at least one housing along a total length of the one housing, so that it is more difficult to achieve both the stable assembling structure of the housings and the smooth opening/closing operation at the same time. Further, as the cumulative use increases over time and the opening/closing operation is repeated over and over, the part opened/closed during the sliding of the housing becomes scratched due to friction between the two housings, so that the appearance of the terminal deteriorates.

### SUMMARY OF THE INVENTION

Accordingly, the present invention has been made to provide a sliding-type portable terminal having a beautiful appearance and a stable assembling structure between the housings.

Also, the present invention provides a sliding-type portable terminal implementing a smooth opening/closing operation, as well as having a stable assembling structure.

Furthermore, the present invention provides a sliding-type portable terminal which can prevent the appearance of the terminal from being deteriorated even if the opening/closing operation is repeated for a long time.

In accordance with an exemplary aspect of the present invention, there is provided a sliding-type portable terminal including: a first housing; a second housing assembled with the first housing such that the second housing is movable in a linear direction on the first housing while facing the first housing; a front case and a rear case forming the second housing; a pair of sliding rails assembled with inner surfaces on both sides of the rear case, respectively; and a sliding guide arranged on the first housing, wherein the sliding guide includes first guide grooves slidably holding each of said both sides of the rear case and second guide grooves extending in parallel with the first guide grooves and slidably holding the sliding rails, respectively.

The sliding rails are made preferably from Stainless Use Steel (SUS) and at least a part of the sliding rails face an inner surfaces of both side-ends of the rear case and are separated from said the inner surfaces of both side-ends of the rear case.

Further, each of the sliding rails includes fastening pieces extending in parallel from both ends of the sliding rails.

Further, the sliding-type portable terminal further includes a screw or a rivet passing through the rear case or the fastening piece that is fastened with the rear case or fastening piece.

The sliding guide preferably includes a mounting plate fixed to a front surface of the first housing and guide members formed at both sides of the mounting plate, respectively, and the first and second guide grooves are formed on the guide members, respectively.

The guide members are made preferably of a synthetic resin, respectively, and both sides of the mounting plate are bent and face each other, and wherein the guide members are double-injection-molded to surround said both sides of the mounting plate.

According to an aspect of the present invention, by using the elastic force of the sliding rail itself during the sliding of the housings, the portable terminal having the above construction can make at least one part of the sliding guide be in close contact with the inner surface of the rear case of the second housing. Therefore, the portable terminal can restrict unnecessary movement of the second housing relative to the first housing and achieve the smooth sliding of the housings by including at least a part among parts that creates direct friction during the sliding of synthetic resin, such as polyoxymethylene (POM), having an excellent mechanical property of a lubricious property and abrasion-resistance. Further, the elastic force of the sliding rail makes the sliding guide create friction against the inner surface of the rear case of the second housing so that in order to prevent and/or reduce the direct friction between an external surface of the rear case of the second housing and the first housing or between the external surface of the rear case of the second housing and the sliding guide. Therefore, the present invention advantageously permits a reduction in the deterioration (e.g. wear and tear) of an appearance of the terminal caused by the friction during the sliding.

### BRIEF DESCRIPTION OF THE DRAWINGS

The above and other exemplary aspects, features and advantages of the present invention will become more apparent from the following detailed description taken in conjunction with the accompanying drawings, in which:

FIG. 1 is a perspective view illustrating a portable terminal according to an exemplary embodiment of the present invention;

FIG. 2 is an exploded perspective view illustrating the principal parts of the portable terminal of FIG. 1;

FIG. 3 is a perspective view illustrating the principal parts of the portable terminal of FIG. 2 seen from another direction;

FIG. 4 is a perspective view illustrating an assembly state of the principal parts of the portable terminal of FIG. 2; and

FIG. 5 is a view illustrating the cut parts of the portable terminal of FIG. 4.

### DETAILED DESCRIPTION

Hereinafter, the first exemplary embodiment of the present invention will be described with reference to the accompanying drawings. In the following description, a detailed explanation of known related functions and constitutions may be omitted to avoid unnecessarily obscuring appreciation of the subject matter of the present invention by a person of ordinary skill in the art.

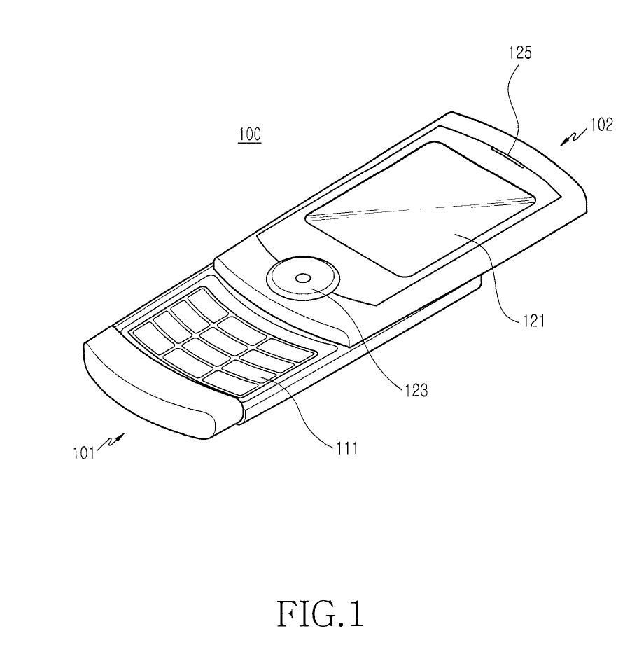

FIG. 1 is a perspective view illustrating a portable terminal 100 according to an exemplary embodiment of the present invention. As shown in FIG. 1, the portable terminal 100 according to an exemplary embodiment of the present invention includes a first housing 101 and a second housing 102 assembled together such that the second housing 102 is slidable on the first housing 101 while being in contact with and facing the first housing. A portion of one surface of the first housing 101 is opened or closed (i.e. accessible or inaccessible) according to the sliding position of the second housing 102. The first housing 101 preferably includes a keypad 111 provided at part of one surface of the first housing that is uncovered/covered by the opening/closing of the second housing 102. When a user carries the portable terminal 100, the second housing 102 overlaps the first housing 101 to close the keypad 111. Further, the user opens and operates the keypad 111 according to his/her necessity, for example, to activate a call mode or a function desired by the user for use.

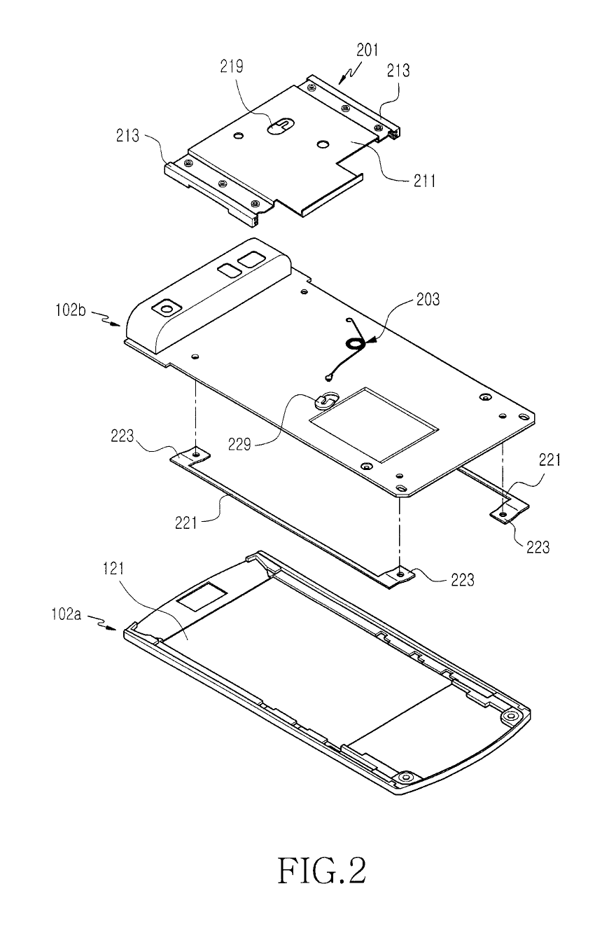

The first housing 101 preferably includes a main board therein and a sliding guide 201 (shown in FIG. 2) is mounted on one surface of the main board. The keypad 111 is opened/closed (uncovered/covered) according to the sliding movement of the second housing 102, while the sliding guide 201 always maintains a hidden state regardless of a change in a position of the second housing 102 because of its slidability. Further, a transmitter (not shown) can be installed in one side of the keypad 111, preferably adjacent to a lower end of the first housing 101. A battery pack and a battery cover can be mounted on a rear surface of the first housing 101.

With continued reference to FIG. 1, the second housing 102 has a window 121 installed in a front surface thereof to expose a display device, a search key 123 installed in a lower side of the window 121 to call and move between a menu, and a speaker unit 125 installed at an upper side of the window 121. If the terminal 100 is used for voice communication, the speaker unit 125 can be utilized as a receiver.

The second housing 102 slides on one surface of the first housing 101 to open/close the keypad 111. The terminal 100 additionally includes an elastic member 203 (shown in FIG. 2) to apply a driving force for moving the second housing 102 in an upper or lower direction of the first housing 101.

The elastic member 203 applies the driving (i.e. elastic) force to separate both ends of the elastic member 203 away from each other and a point where both ends of the elastic member 203 are most adjacent is disposed in a center part of a sliding section of the second housing 102. In the present exemplary embodiment, the elastic member 203 includes a coil and free ends extending from the coil, respectively, and provides the elastic force applied in order to separate the free ends away from each other.

Hereinafter, an assembling structure of the first housing 101 and second housing 102 will now be described with reference to FIGS. 2 to 5 in more detail.

The sliding guide 201 has a mounting plate 211 mounted on one surface of the first housing 101 and guide members 213 formed on both sides of the mounting plate 211, respectively. The mounting plate 211 has a support hole 219 provided therein for supporting one end of the elastic member 203 and is preferably made from a metallic material.

Referring now to FIG. 5, both sides of the mounting plate 211 are bent and face each other, and ends of the sides (side ends) of the mounting plate 211 are bent once again in directions in which they approach each other. Both sides of the mounting plate 211 are bent in order to serve as a means capable of solidly assembling the guide members 213.

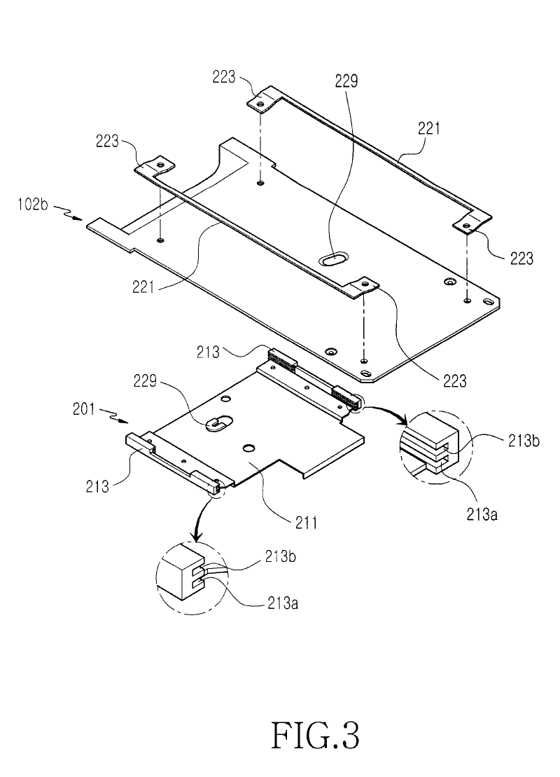

In the meantime, the guide members 213 are arranged at both sides of the mounting plate 211 while facing each other and facing surfaces of the guide members 213 include a first guide groove 213a (FIG. 3) and a second guide groove 213b, respectively. The first and second guide grooves 213a and 213b extend in a sliding direction of the second housing 102 and are disposed in parallel with each other on opposite ends of the mounting plate 211.

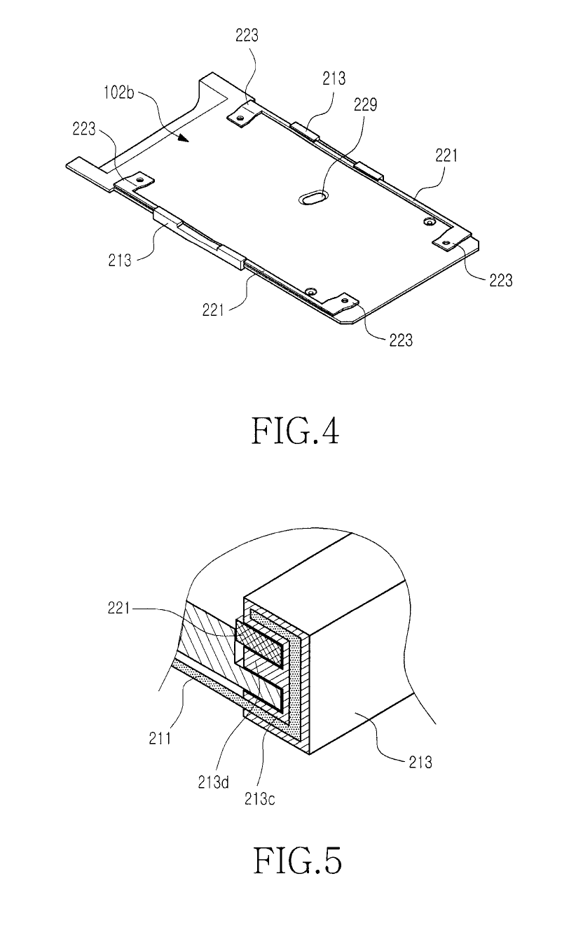

With particular reference to FIG. 4, the first and second guide grooves 213a and 213b surround a rear case 102b of the second housing 102 or a sliding rail 211 to be described later, respectively, so that the first and second guide grooves 213a and 213b directly engage with the rear case 102b of the second housing 102 or the sliding rail 211 if the second housing 102 slides. Therefore, in order to decrease noise according to the friction or improve the smoothness of the sliding, the guide member 213 is preferably made of a synthetic resin, for example, polyoxymethylene (POM) or an acetal having the excellent mechanical characteristic, such as abrasion-resistance, and a lubricious property.

If the product is made of synthetic resin, it is preferred to use injection molding. In this case, it is possible to omit the assembling process by mounting the guide member 213 on the mounting plate 211 simultaneously during the double injection molding of the guide member 213. In other words, by manufacturing the mounting plate 211 of the metallic material and then molding the guide member 213 in a state where the manufactured mounting plate is inserted into an injection mold, it is possible to mount the guide member on the mounting plate 211 without incurring an additional assembling process.

The second housing 102 is provided with a front case 102a including the window 121, or the like, and the rear case 102b assembled with a rear surface of the front case 102 to complete the second housing 102. Both sides of the rear case 102b are assembled with the sliding guide 201 such that the second housing 102 is slidably assembled along the first housing 101. The rear case 102b of the second housing 102 has another support hole 229 for supporting the other end of the elastic member 203 by providing an elastic force.

The rear case 102b includes a pair of sliding rails 221 made of Stainless Use Steel (SUS) on both sides thereof. The sliding rails 221 extend along the sliding direction of the second housing 102 and are in contact with the inner surfaces of both sides of the rear case 102b parallel to a movable direction of the second housing.

Fastening pieces 223 extend in parallel on both ends of the sliding rail 221. The fastening pieces 223 are fixed on the inner surface of the rear case 102b and preferably have a bent shape so as for the sliding rail 221 to be separated from the inner surface of the rear case 102. In order to fix the fastening piece 223 to the rear case 102b of the second housing 102, it is possible to perform ultrasonic welding by using a fusion protrusion formed on the inner surface of the second housing 102 or to use a fastener such as a screw for assembling the fastening piece 213. Further, a rivet that passes through the rear case 102 or the fastening piece 223 is then fastened with the fastening piece 223 or rear case 102 can be provided instead of ultrasonic welding. It is preferred to fix the fastening piece 223 to the rear case 102 by using screws in order to be able to repair of the terminal during the use of the terminal. Welding is a more permanent connection and can be difficult to undo.

In the meantime, the sliding rail 221 extends in the sliding direction of the second housing 102. However, the sliding rail 221 may be bent in a direction in which the sliding rail 221 becomes closer to the inner surface of the rear case 102b. If the sliding rail 221 made of SUS is installed in a bent state, and a certain object is disposed between the sliding rail 221 and rear case 102b, the sliding rail 221 provides pressure to the object so that the object stays in close contact with the inner surface of the rear case 102b.

FIGS. 4 and 5 illustrate the assembling state of the sliding guide 201 in a state that the sliding rail 221 is installed on the rear case 102, respectively. If the sliding rail 221, the rear case 102b, and the sliding guide 201 are all assembled, both of the sides of the rear case 102b are engaged with the first guide groove 213a, respectively, and the sliding rail 221 is engaged with the second guide groove 213b. In this state, if the front case 102a is assembled with the rear case 102b, the front case 102a preferably surrounds the guide members 213 so that the sliding guide 201 is prevented from exposure to the outside. In other words, a certain interval is secured between the inner surface of the front case 102a and both of the sides of the rear case 102b.

It can be noted that a part (hereinafter, referred to as ‘spacer’) 213c of the guide member 213 is disposed between the mounting plate 211 and the rear case 102b and secures a predetermined interval between the mounting plate 211 and the rear case 102b. Due to this predetermined interval, it is possible to prevent (or greatly reduce) the direct friction generated between the mounting plate 211 and the rear case 102b. Further, as described above, the sliding rail 221 provides pressure to the object disposed between the sliding rail 221 and the rear case 102b in a direction in which the object is in close contact with the inner surface of the rear case 102b. At this time, a rib 213d formed between the first and second guide grooves 213a and 213b is in close contact with the inner surface of the rear case 102b. Therefore, even if the spacer 213c is not definitely formed, it is possible to secure the predetermined interval between the mounting plate 211 and the rear case 102b at all times.

In the meantime, the guide member 213 is arranged on the rear case 102b while surrounding both sides of the rear case 102b so that movement of the second housing 102 can be prevented in a substantially lateral direction, i.e. in a left and right direction of the first housing 101, assuming the sliding direction of the second housing 102 is in an upper and a lower direction. Further, the sliding rail 221 applies pressure to the rib 213d in a direction in which the rib 213d is in close contact with the inner surface of the rear case 102b in order to prevent the second housing 102 from moving in a front and rear direction of the first housing 101.

Finally, with regard to the second housing 102, movement in any other direction, except for its original movement direction, is restricted, so as to achieve the stable opening/closing operation. In the meantime, the rib 213d creates friction between the sliding rail 221 and the rear case 102b. In this case, if the rib 213d, i.e. the entire guide member 213, is made of synthetic resin having a lubricous property, such as POM or polyacetal, then a smooth sliding operation can be achieved.

While the present invention has been shown and described with reference to certain exemplary embodiments and drawings thereof, it will be understood by those skilled in the art that various changes in form and details may be made therein without departing from the spirit and scope of the invention as defined by the appended claims.

What is claimed is:

1. A sliding-type portable terminal comprising:
a first housing;
a second housing formed by a front case and a rear case, said second housing being slidably attached to the first housing such that the second housing is linearly movable along the first housing while facing the first housing;
a pair of sliding rails arranged with inner surfaces on both sides of the rear case, respectively, parallel to a movable direction of the second housing; and
a sliding guide arranged on the first housing,
wherein the sliding guide comprises first guide grooves arranged on both sides of the rear case for slidably receiving each respective side of said both sides of the rear case, and
wherein said sliding guide further comprises second guide grooves extending with the first guide grooves in parallel and slidably holding the sliding rails, respectively.

2. The sliding-type portable terminal as claimed in claim 1, wherein the sliding rails are comprised of Stainless Use Steel (SUS) and at least a part of the sliding rails face inner surfaces of both sides of the rear case, and are separated from said the inner surfaces of both sides of the rear case.

3. The sliding-type portable terminal as claimed in claim 1, wherein each of the sliding rails comprises fastening pieces extending in parallel from both ends of the sliding rails.

4. The sliding-type portable terminal as claimed in claim 2, wherein each of the sliding rails comprises fastening pieces extending in parallel from both ends of the sliding rails.

5. The sliding-type portable terminal as claimed in claim 3, further comprising a screw or a rivet, which passes through the rear case or one of the fastening pieces and is fastened with one of the fastening pieces or the rear case.

6. The sliding-type portable terminal as claimed in claim 1, wherein the sliding guide comprises a mounting plate fixed to a front surface of the first housing and guide members formed at both sides of the mounting plate, respectively, and the first and second guide grooves are formed on the guide members, respectively.

7. The sliding-type portable terminal as claimed in claim 2, wherein the sliding guide comprises a mounting plate fixed to a front surface of the first housing and guide members formed at both sides of the mounting plate, respectively, and the first and second guide grooves are formed on the guide members, respectively.

8. The sliding-type portable terminal as claimed in claim 6, wherein the guide members are comprised of synthetic resin.

9. The sliding-type portable terminal as claimed in claim 8, wherein said both sides of the mounting plate are bent and face each other and the guide members are formed by double-injection-molding to surround said both sides of the mounting plate.

10. The sliding-type portable terminal as claimed in claim 6, wherein the guide members are comprised of a synthetic resin.

11. The sliding-type portable terminal as claimed in claim 10, wherein the synthetic resin comprises one of polyoxymethylene (POM) or an acetal having a predetermined mechanical characteristic.

12. The sliding-type portable terminal as claimed in claim 11, wherein the predetermined mechanical characteristic includes at least one of abrasion-resistance, and a lubricious property.

13. The sliding-type portable terminal as claimed in claim 1 further comprising an elastic member for applying a driving force for moving the second housing relative to the first housing.

14. The sliding-type portable terminal as claimed in claim 6, wherein the guide members are arranged on the rear case while surrounding both sides of the rear case so that movement of the second housing in a substantially lateral direction is prevented.

15. The sliding-type portable terminal as claimed in claim 6, where the guide members include a spacer disposed between the mounting plate and the rear case to secures a predetermined interval between the mounting plate and the rear case.
